(19) United States
(12) Patent Application Publication
(10) Pub. No.: US 2025/0181945 A1
(43) Pub. Date: Jun. 5, 2025

(54) BUFFERS FOR STREAMING IN QUANTUM-CENTRIC SUPERCOMPUTING

(71) Applicant: International Business Machines Corporation, Armonk, NY (US)

(72) Inventors: Iskandar Sitdikov, New York, NY (US); Pedro Rivero Ramirez, Long Island City, NY (US); Derek Wang, New York, NY (US)

(21) Appl. No.: 18/526,334

(22) Filed: Dec. 1, 2023

(51) Int. Cl. G06N 10/20

(52) U.S. Cl. CPC G06N 10/20

(57) ABSTRACT

One or more systems, devices, computer program products and/or computer-implemented methods of use provided herein relate to buffers for streaming in quantum-centric supercomputing. A system can comprise a memory that can store computer-executable components. The system can further comprise a processor that can execute the computer-executable components stored in the memory, wherein the computer-executable components can comprise a receiver component that can receive, from a source node, a quantum input and a release criterion associated with the quantum input. The computer-executable components can further comprise a computation component that can perform a computation based on the quantum input, in a buffering environment, to generate a result that can meet the release criterion.

### BACKGROUND

The subject disclosure relates to quantum computing, and more specifically to buffers for streaming in quantum centric supercomputing.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits that comprise superpositions of both 0 and 1, can entangle multiple quantum bits, and use interference. Quantum computing can involve large payloads, wherein payloads can represent data transmitted between modules. Payloads needing real-time decision making should be streamed and not batched. However, coordinating streaming of large payloads across diverse use cases can be challenging.

The above-described background description is merely intended to provide a contextual overview regarding quantum computing and quantum payloads and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable buffers for streaming in quantum-centric supercomputing are discussed.

According to an embodiment, a system is provided. The system can comprise a memory that can store computer-executable components. The system can further comprise a processor that can execute the computer-executable components stored in the memory, where the computer-executable components can comprise a receiver component that can receive, from a source node, a quantum input and a release criterion associated with the quantum input. The computer-executable components can further comprise a computation component that can perform a computation based on the quantum input, in a buffering environment, to generate a result that can meet the release criterion. Such embodiments of the system can provide a number of advantages, including efficient and speedy transmission of payloads between modules to allow for streaming data for real-time decision making in quantum-centric supercomputing.

In one or more embodiments of the aforementioned system, generating the result can comprise performing the computation in the buffering environment for at least a first iteration to generate a first result. In one or more embodiments of the aforementioned system, an update component can update the quantum input based on the first result to generate an updated quantum input, such that performing the computation based on the updated quantum input in the buffering environment can generate the result. In an aspect, the update component can further update the updated quantum input based on the result if the result does not meet a release criterion. In one or more embodiments of the aforementioned system, an output component can release an output based on the result to a receiver node, where the receiver node can be a quantum device or a classical device. In one or more embodiments of the aforementioned system, the source node can be a quantum device or a classical device. In one or more embodiments of the aforementioned system, generating the result based on the release criterion can increase efficiency of performing computations for a receiver node. Such embodiments of the system can provide a number of advantages, including efficient and speedy transmission of payloads between modules to allow for streaming data for real-time decision making in quantum-centric supercomputing, improved quantum processing unit (QPU) utilization by minimizing compilation at an end point to a quantum hardware, and faster development of quantum computing products with a flexible and powerful quantum-centric software framework.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can provide a buffering environment for streaming payloads in accordance with one or more embodiments described herein.

FIG. 2 illustrates a flow diagram of an example, non-limiting process of using a buffer for streaming payloads in accordance with one or more embodiments described herein.

FIG. 3 illustrates a diagram of an example, non-limiting implementation of a buffering environment interacting with a classical source node and a classical receiver node in accordance with one or more embodiments described herein.

FIG. 4 illustrates another flow diagram of an example, non-limiting process of using a buffer for streaming payloads in accordance with one or more embodiments described herein.

FIG. 5 illustrates yet another flow diagram of an example, non-limiting process of using a buffer for streaming payloads in accordance with one or more embodiments described herein.

FIG. 6 illustrates yet another flow diagram of an example, non-limiting process of using a buffer for streaming payloads in accordance with one or more embodiments described herein.

FIG. 7 illustrates a flow diagram of an example, non-limiting method that can provide a buffering environment for streaming payloads in accordance with one or more embodiments described herein.

FIG. 8 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

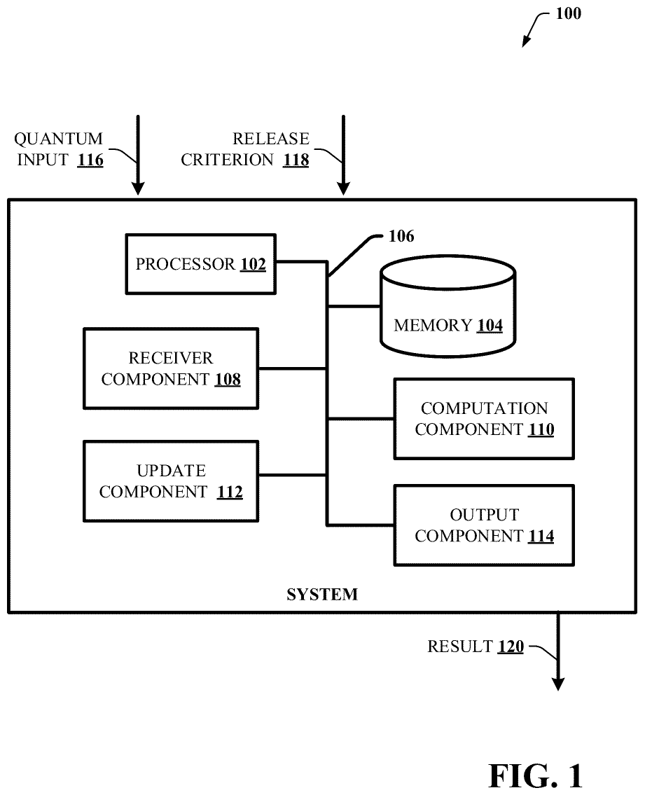

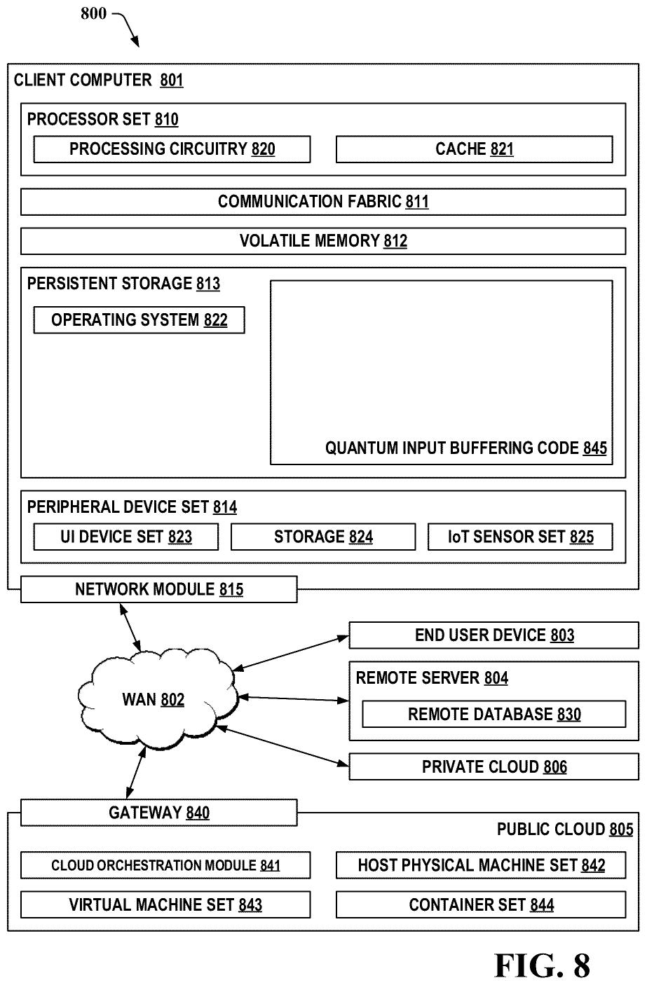

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 800 illustrated at FIG. 8. For example, system 100 can be associated with, such as accessible via, a computing environment 800 described below with reference to FIG. 8, such that aspects of processing can be distributed between system 100 and the computing environment 800. In one or more described embodiments, computer and/or computing-based elements can be used in connection with implementing one or more of the systems, devices, components and/or computer-implemented operations shown and/or described in connection with FIG. 1 and/or with other figures described herein.

Quantum-centric supercomputing is the path towards useful quantum computing. Quantum-centric supercomputing can be defined as a modular computing architecture that can enable scaling, and combining communication and computation to increase computational capacity, while employing hybrid cloud middleware to seamlessly integrate quantum and classical workflows. An example of quantum-centric supercomputing can comprise circuit cutting to fit larger quantum circuits on smaller quantum devices, wherein such circuit cutting can enable collecting and processing results of tomography on circuit fragments. Another example of quantum-centric supercomputing can comprise error mitigation methods with a large classical overhead, wherein such error mitigation can enable storing device noise parameters, generating mitigation circuits in real-time (e.g., on the fly), and collecting and processing results of mitigation circuits to stream mitigated expectation values. In general, quantum-centric supercomputing can comprise a network of classical computers tied to quantum computers and involve significant complex timing, large amounts of data flowing between computing units, different data sizes, different buffer times and so on. Data to be transmitted from one module to another can be known as payloads. In quantum-centric supercomputing, input circuits and output results, for example, can be payloads, with several payloads being transmitted back and forth between modules and significant real-time decision making involved.

Payloads needing real-time decision making should be streamed and not batched. Streaming data can refer to instantly using incoming data for computations, as opposed to batch processing, which can refer to collecting a chunk of data and sending the collected data to a computer, at once, for further computation and decision making. Streamed payloads can be processed sequentially and incrementally on a record-by-record basis or over sliding time windows and used for a wide variety of analytics including, correlations, aggregations, filtering, and sampling. Information derived from such analysis can provide visibility to companies into many aspects of business and customer activity. In general, stream processing can involve processing within a rolling time window. For example, in case of classical computing, stream processing can involve data in the form of individual records or micro batches, less latency and simpler analysis. Table 1 highlights differences between stream processing and batch processing.

TABLE 1

| | Batch processing | Stream processing |
|---|---|---|
| Data scope | Processing the | Processing within a rolling time window |
| | entire dataset | |
| Data size | Large | Individual records or micro batches |
| Latency | Minutes to hours | Seconds or milliseconds |
| Analysis | Complex analysis | Simple response functions, aggregates, |
| | | rolling metrics |

Although payloads needing real-time decision making should be streamed, coordinating streaming of large payloads in real-time across diverse use cases can be challenging. In this regard, existing solutions involve batch processing of data and do not provide a paradigm to handle diverse real-time payloads. Further, existing hybrid quantum-classical computational workflows are specific to applications and not generalizable under a streaming framework, and some existing approaches do not allow for low-level interactive access. For applications involving convergence criteria as a parameter, some existing technologies can specify the number of samples of the parameter to be taken for attaining the convergence criteria. However, doing so can be problematic because in some scenarios, the convergence criteria is met significantly before the specified number of samples can be taken, leading to over sampling without adding value to a given task, whereas in other scenarios, convergence is not achieved even after taking the specified number of samples. Thus, an efficient method for streaming payloads for real-time decision making based on quantum computing-specific inputs can be desirable.

Various embodiments of the present disclosure can be implemented to produce a solution to one or more of the problems discussed above. Embodiments described herein include systems, computer-implemented methods, and computer program products that can enable buffers for streaming payloads in quantum-centric supercomputing. For example, in various embodiments, a buffer can interact with a source node to receive inputs. In various embodiments, the source node can be a classical device or classical computer (e.g., a central processing unit (CPU) or a quantum device or quantum computer (e.g., QPU), and the inputs can be quantum inputs comprising gates, circuit layers, circuits, groups of circuits, bitstring counts, probabilistic distributions, expectation values, and so on. Inputs comprising gates, circuit layers, circuits, groups of circuits, etc. can be received from the classical device and inputs comprising bitstring counts, probabilistic distributions, expectation values, etc. can be received from the quantum device.

In various embodiments, the buffer can additionally receive from the classical device or the quantum device, release criteria associated with respective inputs. The release criteria can comprise, time window criteria, convergence criteria, sufficient compression criteria, or criteria for minimum or maximum memory size or dataset size, and so on. In various embodiments, the buffer can store the inputs in memory, process the inputs in iterations, and compare a result of processing the inputs with respective release criteria. For example, the buffer can perform a computation based on an input to generate a first result, update the input based on the first result if the first result does not meet the release criterion, reperform the computation using the first result to generate a second result, and so on. The buffer can perform the computation until the release criterion can be satisfied. In various embodiments, upon generating a result that can satisfy the release criterion, the buffer can perform an additional computation based on the result, and the buffer can release an output of the additional computation to a receiver node. The receiver node can perform further processing of the output or execute actions based on the output received from the buffer. In various embodiments, the receiver node can also be a classical device or classical computer (e.g., a CPU) or a quantum device or quantum computer (e.g., a QPU). In various embodiments, inputs can be received by the buffer and outputs can be released by the buffer via cloud transmissions.

In various embodiments, the buffer can be implemented by a streaming infrastructure to transfer data through channels (topics) and a set of buffer instances. An approach implemented by the buffer on a computation payload can allow data to be processed in sequences of small packets, which can allow the buffer to implement streaming techniques like back pressure, parallel processing, etc. as well as unique quantum computational workloads such as transpilation, error mitigation, expectation value calculation, etc. Buffer instances can be implemented in any programming language. The streaming infrastructure of the buffer can be a computational node comprising a memory and small computer. The buffer can store the inputs in the memory, and the buffer can employ the computer to perform calculations on the stored inputs to process the inputs. In various embodiments, the memory can be a classical memory and/or a quantum memory, and the computer can be a classical computer (e.g., a CPU) and/or a quantum computer (e.g., a QPU). For example, because the inputs received by the buffer can comprise quantum mechanical information needing storage in a quantum memory, the buffer can employ a quantum memory in addition to a classical memory. For example, the buffer can receive a quantum state from a quantum computer, and the buffer can store the quantum state in the quantum memory.

Thus, a buffer can be a classical computational node, a quantum computational node or both, a classical computational node, and a quantum computational node. Since computations performed by the buffer can involve processing of a limited amount of information, the buffer can be a compact computational resource of the type needed for performing a particular task based on acceptance and release criteria. In other words, a buffer can be a small intermediary device between larger computing nodes. Additional aspects of buffers will now be described in greater detail with reference to the figures.

Turning now to FIG. 1 illustrated is a block diagram of an example, non-limiting system 100 that can provide a buffering environment for streaming payloads in accordance with one or more embodiments described herein.

System 100 and/or the components of system 100 can be employed to use hardware and/or software to solve problems that are highly technical in nature (e.g., related to quantum supercomputing, buffers, streaming payloads, etc.), that are not abstract and that cannot be performed as a set of mental acts by a human. Further, some of the processes performed may be performed by specialized computers for carrying out defined tasks related to buffers for streaming payloads in quantum-centric supercomputing. The system 100 and/or components of the system can be employed to solve new problems that arise through advancements in technologies mentioned above, computer architecture, and/or the like. The system 100 can provide technical improvements to quantum computing systems by enabling efficient and speedy data transmission between computing nodes without overloading a network. For example, various embodiments herein can provide for streaming of large payloads, wherein data can be transmitted in bits and real-time computations can be performed on the data, instead of transmitting data at once in large chunks (e.g., many gigabytes (GB)) and processing such payloads in batches.

System 100 can provide additional improvements in terms of sampling and accuracy. For example, by employing system 100, information can be sampled fewer number of times from a quantum computer, and an overall amount of data to be transmitted can be smaller. Further, by employing system 100, a number of samples to be acquired for an application can be specified beforehand, which can ensure that a result generated based on the specified number of samples can have a certain accuracy, as opposed to guessing the number of samples or checking for validity of the result afterwards. For example, in an application of dynamic termination with adaptive zero-noise extrapolation, batch processing can involve a user guessing noise amplification factors, extrapolation functions, and the number of shots. Further, the user can submit a batch of noise-amplified circuits (up to many GB), receive a batch of counts for each circuit, estimate a zero-noise expectation value with error bars defined by a number of shots, and repeat the steps described heretofore, if results are not precise. On the contrary, streaming data for the same application can involve the user defining the level of precision needed for a result and a buffer window rate and submitting a single target circuit (few megabytes (mb)). Thereafter, system 100 can iteratively execute a streaming process between a cloud-hosted CPU and QPU. During the buffering process, batches of noise-amplified circuits can be transmitted on a circuit-by-circuit basis to an endpoint, zero-noise expectation values can be returned to the CPU at the buffer window rate, the CPU can automatically select new noise amplification factors, an extrapolation function, and shots, and system 100 can repeat the process until desired precision is achieved. Finally, the user can receive results with a guaranteed precision.

Discussion turns briefly to processor 102, memory 104 and bus 106 of system 100. For example, in one or more embodiments, the system 100 can comprise processor 102 (e.g., computer processing unit, microprocessor, classical processor, quantum processor and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to processor 102. Memory 104 can store computer-executable instructions that, upon execution by processor 102, can cause processor 102 and/or one or more other components of system 100 (e.g., receiver component 108, computation component 110, update component 112, and/or output component 114) to perform one or more actions. In one or more embodiments, memory 104 can store computer-executable components (e.g., receiver component 108, computation component 110, update component 112, and/or output component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, system 100 can be a buffer that can enable streaming payloads for real-time decision making in quantum-centric supercomputing. In various embodiments, receiver component 108 can receive, from a source node, quantum input 116 and release criterion 118 associated with quantum input 116. In various embodiments, the source node can be a classical computer or a quantum computer, and quantum input 116 can comprise quantum gates, quantum circuit layers, quantum circuits, groups of quantum circuits, bitstring counts, probabilistic distributions, or expectation values, and so on. Quantum input 116 comprising quantum gates, quantum circuit layers, quantum circuits, or groups of quantum circuits, etc. can be received from the classical device and quantum input 116 comprising bitstring counts, probabilistic distributions, or expectation values, etc. can be received from the quantum device. In various embodiments, release criterion 118 can comprise a time window criterion, convergence criterion, sufficient compression criterion, a criterion for minimum or maximum memory, or a criterion for minimum or maximum dataset size, and so on. Release criterion 118 can be specific to quantum input 116.

In various embodiments, system 100 can store quantum input 116 in memory 104, and computation component 110 can perform a computation based on quantum input 116, in a buffering environment, to generate a result that can meet release criterion 118. Generating the result can comprise performing the computation in the buffering environment for at least a first iteration to generate a first result. In various embodiments, update component 112 can update quantum input 116 based on the first result to generate an updated quantum input, such that performing the computation based on the updated quantum input, in the buffering environment, can generate the result that can meet release criterion 118. In an aspect, update component 112 can further update the updated quantum input based on the result if the result does not meet release criterion 118.

More specifically, computation component 110 can perform a computation based on quantum input 116, in a buffering environment, to generate result 120, wherein result 120 can represent a result that can meet release criterion 118. For example, in various embodiments, generating result 120 can comprise performing the computation in the buffering environment for at least a first iteration to generate a first result. In various embodiments, update component 112 can check if the first result meets release criterion 118. If the first result does not meet release criterion 118, update component 112 can update quantum input 116 based on the first result to generate an updated quantum input. Thereafter, computation component 110 can reperform the computation based on the updated quantum input, in the buffering environment, to generate a second result. In various embodiments, update component 112 can check if the second result meets release criterion 118. If the second result does not meet release criterion 118, update component 112 can further update the updated quantum input based on the second result. Thus, system 100 can perform computations in iterations until a result that can satisfy release criterion 118 (e.g., result 120) can be generated.

In various embodiments, upon generating result 120, computation component 110 can perform another computation based on result 120 to generate an output, and output component 114 can release the output to a receiver node that can perform further processing of the output or execute actions based on the output. Stated differently, system 100 can release the output to the receiver node based on release criterion 118. In various embodiments, the receiver node can be a classical computer or a quantum computer. In various embodiments, quantum input 116 can be received by receiver component 108, and the output can be released by output component 114 via cloud transmissions. In various embodiments, generating result 120 based on release criterion 118 can increase efficiency of performing computations for the receiver node. For example, in certain scenarios, the receiver node can perform more timely computations by utilizing the output based on result 120 as compared to utilizing an output not based on result 120, because the output based on result 120 can comprise the exact information needed by the receiver node, and the receiver can begin computations right away. For similar reasons, in certain other scenarios, the receiver node can perform less computations because the receiver node can receive the exact information needed to generate further results.

In various embodiments, system 100 can be a buffer that can be implemented via a streaming infrastructure to transfer data through channels (topics) and a set of implemented buffer instances. As such, the buffer can provide a software framework that can enable an end-to-end protocol with several stages in between. For example, the buffer can receive quantum input 116 (e.g., a quantum circuit, results from a sampling process, gates, shots, expectation values, quantum memory limits, etc.) and generate result 120, wherein result 120 can be utilized for subsequent computations. An approach implemented by the buffer on a computation payload (e.g., quantum input 116) can allow data to be processed in sequences of small packets, which can allow the buffer to implement streaming techniques like back pressure, parallel processing, etc. as well as unique quantum computational workloads such as transpilation, error mitigation, expectation value calculation, etc. Buffer instances can be implemented in any programming language. Algorithm 1 can be an algorithm of the software framework that can implement buffering instances.

Algorithm 1:

```
trait Type {
  pub fn process(inputs: HashMap)
  pub fn checkCriteria( ) −> Bool
  pub fn release(sink: Channel)
}
pub struct Buffer<T: Type> {
  source: Channel // inputs channel
  sink: Channel // output channel
}
impl<T: Type> Buffer<T> {
  [#listen(source)] // stream handler listens to input channel
  pub fn handle(inputs: HashMap) {
    T.process(inputs); // process input
    if T.checkCriteria( ) { // check release criterion
      T.release(sink: Channel); // release if criteria met to out channel
    }
  }
}
```

Further, the buffer can represent a computational node comprising memory 104 and processor 102. System 100 can store quantum input 116 in memory 104, and system 100 can employ processor 102 to perform calculations based on quantum input 116. In various embodiments, memory 104 can represent a classical memory (e.g., a hard drive, etc.) and/or a quantum memory, and processor 102 can represent a classical processor (e.g., a CPU) and/or a quantum processor (e.g., a QPU). For example, because quantum input 116 can comprise quantum mechanical information needing storage in a quantum memory, system 100 can need a quantum memory for storage of quantum input 116. For example, system 100 can receive a quantum state that can need a quantum memory for storage. Thus, system 100 can be a classical computational node, a quantum computational node or both, a classical computational node, and a quantum computational node. Since computations performed by system 100 can involve processing of a limited amount of information, system 100 can be a compact computational resource of the type needed for performing a particular task based on release criteria. As such, system 100 can be a small intermediary device between larger nodes.

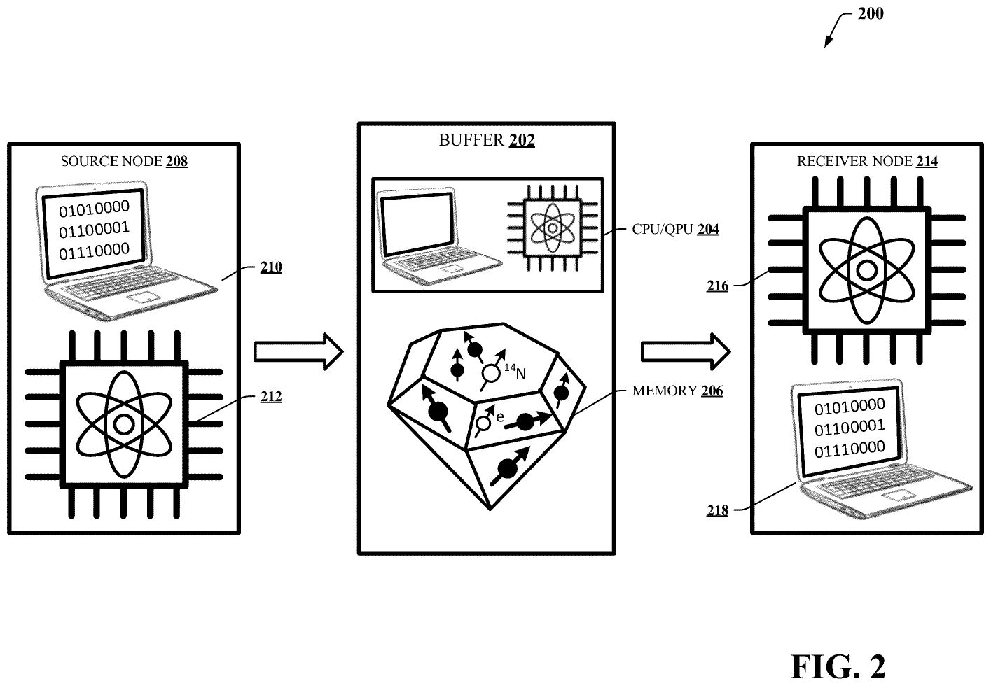

System 100 can be employed for various applications, some of which are listed in table 2. As evident from Table 2 and as stated elsewhere herein, the source node can be a classical computer or a quantum computer, the receiver node can be a classical computer or a quantum computer, and system 100 can comprise a classical computer, a quantum computer or both, a classical computer, and a quantum computer. For example, for state verification, system 100 can be a quantum computer that can receive quantum information, such as a quantum state, and generate an output by performing a calculation that can determine fidelity of the quantum state with another quantum state of interest (e.g., a reference quantum state). System 100 can release the output to a receiver node, wherein the receiver node can feed the output to another quantum computer. Thus, system 100 can receive individual quantum states and generate an output for each quantum state as opposed to, for example, receiving 100 quantum states, performing 100 calculations to generate 100 outputs, and releasing the 100 outputs at once to the receiver node. Further, the receiver node can decide upon an action to perform, based on the output, on a quantum state-by-quantum state basis. Similar processes can apply to other examples listed in FIG. 2, each of which are explained in greater detail with reference to subsequent figures.

TABLE 2
Examples of applications of system
100 for real-time decision making.

| | Source | Input from | Output to | Receiver |
|---|---|---|---|---|
| Applications | node | source | receiver | node |
| On-the-fly | Classical | Gates | Circuit layer | Classical |
| transpilation | | | | |
| Complex | Classical | Pauli | Quantum circuit | Quantum |
| operator | | observables | with simultaneous | |
| estimation | | | measurement | |
| Dynamic | Quantum | Noise- | Converged | Classical |
| termination of | | amplified | expectation | |
| expectation | | expectation | values | |
| value | | values | | |
| estimation | | | | |
| State | Quantum | Quantum | Fidelity | Quantum |
| verification | | states | | |

System 100 can unlock new capabilities in quantum-centric supercomputing. For example, system 100 can provide for efficient transmission of payloads, even as quantum devices go from 100 qubits to 400 qubits to 1000 qubits to 100,000 qubits. Further, system 100 can allow real-time decision making in quantum computing, including, dynamic termination, quantum error correction, and adaptive error mitigation. System 100 can additionally provide improved QPU utilization (U-metrics) by minimizing compilation at an end point to a quantum hardware, and faster development with a flexible and powerful quantum-centric software framework. In general, system 100 can enable streaming data in quantum-centric supercomputing, wherein streaming data can have advantages over batch processing of data.

FIG. 2 illustrates a flow diagram of an example, non-limiting process 200 of using a buffer for streaming payloads in accordance with one or more embodiments described herein. One or more embodiments described with reference to FIG. 2 can be performed by one or more components of FIG. 1. Repetitive description of like elements and/or processes employed in respective embodiments is omitted for sake of brevity.

In various embodiments, buffer 202 (e.g., system 100) can enable streaming payloads for real-time decision making in quantum-centric supercomputing. For example, buffer 202 can interact with source node 208 to receive inputs and release criteria specific to respective inputs. In various embodiments, source node 208 can be a classical computer 210 or a quantum computer 212, and the inputs can be quantum inputs comprising quantum gates, quantum circuit layers, quantum circuits, groups of quantum circuits, bitstring counts, probabilistic distributions, or expectation values, and so on. Quantum inputs comprising quantum gates, quantum circuit layers, quantum circuits, or groups of quantum circuits, etc. can be received from classical computer 210 and quantum inputs comprising bitstring counts, probabilistic distributions, or expectation values, etc. can be received from quantum computer 212. Buffer 202 can hold the quantum inputs in a memory associated with buffer 202, and release the inputs based on the release criteria.

In various embodiments, the release criteria can comprise a time window criterion, a convergence criterion, a sufficient compression criterion, or a criterion for minimum or maximum memory or dataset size, and so on. Respective release criteria (e.g., release criterion 118) can be specific to respective quantum inputs (e.g., quantum input 116). In classical supercomputing, a release criterion can often be a time window, wherein information can be collected with a sensor, and the information can be released at specified time intervals, for example, very 100 microseconds (μs). In quantum supercomputing, convergence can also be a significant release criterion because quantum computers are probabilistic machines that can collect data over several shots, and users can aim for results to converge after collecting data over enough shots. As such, various embodiments herein can adapt various release criteria for quantum supercomputing. Another release criterion in quantum supercomputing can be a minimum/maximum memory or dataset size. In certain applications, information can be collected until a specified number of data points are acquired, the specified number of data points are exceeded, or a maximum number of the data points are acquired. As such, various embodiments herein can define general release criteria that can apply to different applications in quantum supercomputing.

In various embodiments, buffer 202 can store the quantum inputs in a memory and perform (e.g., using computation component 110) a computation based on the quantum inputs, in a buffering environment, to generate a result (e.g., result 120) that can meet release criterion 118. For example, in various embodiments, buffer 202 can be a quantum computer that can perform a quantum computation based on a quantum input for at least a first iteration to generate a first result. In various embodiments, buffer 202 can check (e.g., using update component 112) if the first result meets a release criterion specific to the quantum input. If the first result does not meet the release criterion, buffer 202 can update the quantum input based on the first result to generate an updated quantum input. Thereafter, buffer 202 can reperform (e.g., using computation component 110) the quantum computation based on the updated quantum input, in the buffering environment, to generate a second result. In various embodiments, buffer 202 can check (e.g., using update component 112) if the second result meets the release criterion. If the second result does not meet the release criterion, buffer 202 can further update (e.g., using update component 112) the updated quantum input based on the second result. Thus, buffer 202 can perform quantum computations in iterations until a result that can satisfy the release criterion can be generated.

In various embodiments, upon generating the result, buffer 202 can perform (e.g., using computation component 110) another computation based on the result to generate an output, and buffer 202 can release (e.g., using output component 114) the output to receiver node 214, wherein receiver node 214 can perform further processing of the output or execute actions based on the output. In various embodiments, receiver node 214 can be quantum computer 216 or classical computer 218. In various embodiments, the quantum input can be received by buffer 202 (e.g., via receiver component 108) and the output can be released by buffer 202 (e.g., via output component 114) through transmissions over a cloud network. In various embodiments, generating the result based on the release criterion can increase efficiency of performing computations for receiver node 214.

In summary, buffer 202 can be employed using the following steps.

Step 1: Buffer 202 can be defined by an input, a release criterion, and an output.

Step 2: Buffer 202 can accept the input in memory.

Step 3: Buffer can process the input.

Step 4: Buffer 202 can check for a release criterion.

Step 5: Buffer 202 can repeat steps 2-4 until a result that can meet the release criterion can be met.

Step 6: Buffer 202 can compute the output based on the result.

Step 7: Buffer 202 can release the output to receiver node 214.

As discussed in one or more embodiments, buffer 202 can be implemented via a streaming infrastructure to transfer data through channels (topics) and a set of implemented buffer instances. As such, buffer 202 can provide a software framework that can enable an end-to-end protocol with several stages in between. Further, buffer 202 can represent a computational node comprising a memory and a computer, such that buffer 202 can store the quantum input in the memory and employ the computer to perform calculations based on the quantum input. An approach implemented by buffer 202 on a computation payload (e.g., quantum input 116) can allow data to be processed in sequences of small packets, which can allow buffer 202 to implement streaming techniques like back pressure, parallel processing, etc. as well as unique quantum computational workloads such as transpilation, error mitigation, expectation value calculation, etc. Buffer instances can be implemented in any programming language.

In various embodiments, the memory can be a classical memory (e.g., a hard drive, etc.) and/or a quantum memory (e.g., memory 206), and the computer can be a classical computer and/or a quantum computer (e.g., CPU/QPU 204). For example, because information received by buffer 202 from source node 208 can comprise quantum mechanical information, buffer 202 can need memory 206 for storage of the quantum mechanical information. For example, buffer 202 can receive a quantum state that can need a quantum memory for storage. In FIG. 2, memory 206 is illustrated as a diamond with arrows and atoms embedded, which represents one way of illustrating a quantum memory. The arrows and atoms can represent defects in a solid-state material, and such materials can often be explored as quantum memories because of their abilities to hold quantum states. Thus, buffer 202 can be a classical computational node, a quantum computational node or both, a classical computational node, and a quantum computational node. Since computations performed by buffer 202 can involve processing of a limited amount of information, buffer 202 can be a compact computational resource of the type needed for performing a particular task based on acceptance and release criteria. As such, buffer 202 can be a small intermediary device between larger nodes. Examples of application of buffer 202 listed in table 2 will now be described in greater detail with reference to subsequent figures.

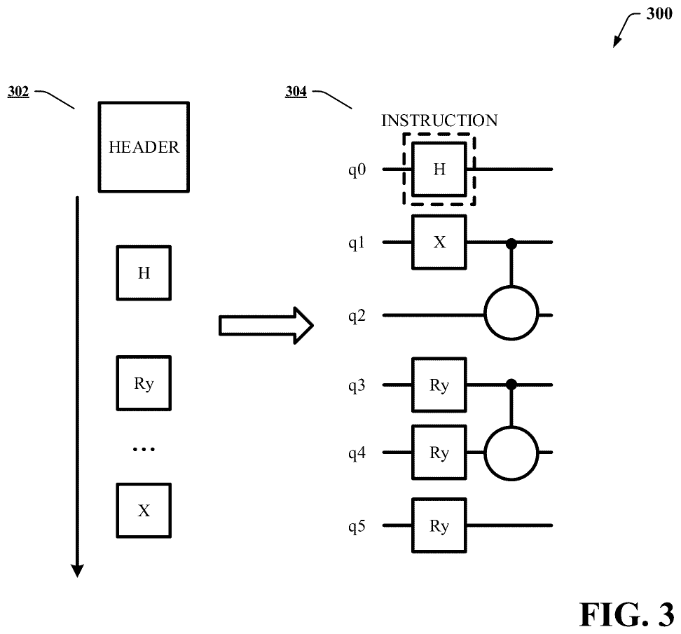

FIG. 3 illustrates a diagram of an example, non-limiting implementation 300 of a buffering environment interacting with a classical source node and a classical receiver node in accordance with one or more embodiments described herein. One or more embodiments described with reference to FIG. 3 can be performed by one or more components of FIG. 1. Repetitive description of like elements and/or processes employed in respective embodiments is omitted for sake of brevity.

One application of quantum computing can be transpilation of quantum circuits, wherein a quantum circuit can be manipulated according to match the topology of a quantum hardware, for noise reduction in the quantum circuit, etc. Such quantum circuits can often be large circuits. With continued reference to FIG. 2, buffer 202 (e.g., system 100) can be used for on-the-fly transpilation of quantum circuits, as opposed to transpiling a large quantum circuit at once. For example, instead of feeding a large quantum circuit to buffer 202 from source node 208, the quantum circuit can be split into layers, and each layer of the quantum circuit can be an input (e.g., quantum input 116) to buffer 202 from source node 208. Buffer 202 can transpile each layer of the quantum circuit at one instance, in real-time, which can reduce wait times experienced for transmitting a quantum circuit (e.g., a large payload) back and forth between modules or computing nodes.

In this application, buffer 202 can accept (e.g., via receiver component 108) individual gates (i.e., individual quantum gates) as inputs, and the release criterion for buffer 202 can be defined as enough gates to form a dense circuit layer (e.g., “Enough gates to form a dense circuit layer”). Buffer 202 can process (e.g., using computation component 110) the individual gates into a circuit layer, and buffer 202 can check (e.g., using computation component 110) whether the aggregated circuit layer is dense before releasing the circuit layer for being added on to a transpiled quantum circuit. If the circuit layer is not dense enough to meet the release criterion, buffer 202 can continue to accept individual gates and process the inputs into the circuit layer until the release criterion is met.

Upon the circuit layer being dense enough to meet the release criterion, buffer 202 can transpile the circuit layer (e.g., using computation component 110) by appending parametrized Pauli gates for twirling, and merging single-qubit gates. For example, at 302, buffer 202 can process individual gates such as, for example, an H gate (or Hadamard gate), an Ry gate (a single-qubit gate that can perform a rotation about the Y-axis by an amount θ), an X gate or a Pauli X gate (a single-qubit gate that can perform a rotation through π radians about the X-axis), etc. in a circuit layer in a topological order, and at 304, buffer 202 can transpile the circuit layer. After transpiling the circuit layer, buffer 202 can release (e.g., using output component 114) the circuit layer transpiled on-the fly. With reference to FIG. 1, the circuit layer released by buffer 202 can represent result 120, and the transpiled circuit layer can represent the output generated by buffer 202 based on result 120.

In this application, source node 208 can be classical computer 210, and receiver node 214 can be classical computer 218. Although the application discussed herein can involve a classical-classical interaction, various embodiments can enable the classical-classical interaction (i.e., a classical communication-to-classical communication interaction) by streaming payloads, as opposed to existing technologies using batch processing for such applications. Further, embodiments discussed herein can enable the technology to be applied to the quantum field.

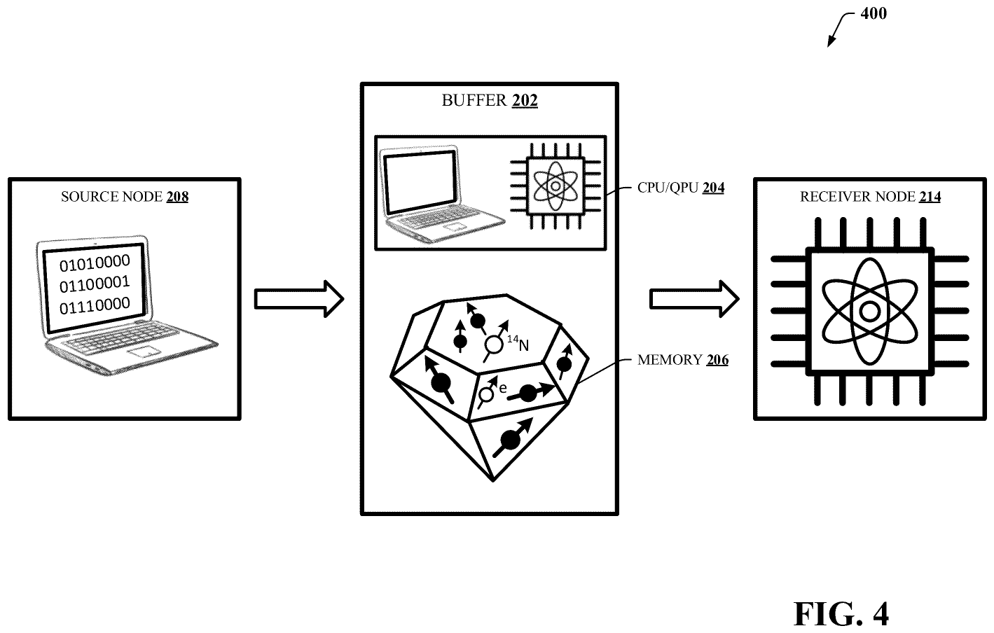

FIG. 4 illustrates another flow diagram of an example, non-limiting process 400 of using a buffer for streaming payloads in accordance with one or more embodiments described herein. One or more embodiments described with reference to FIG. 4 can be performed by one or more components of FIG. 1. Repetitive description of like elements and/or processes employed in respective embodiments is omitted for sake of brevity.

In quantum computing, multiple Pauli operators (or Pauli observables) can often be measured from a quantum circuit, and the Pauli observables can be measured in an efficient manner. With continued reference to FIG. 2, buffer 202 (e.g., system 100) can be used for estimation of complex operators. For example, buffer 202 can be accept (e.g., via receiver component 108) Pauli observables from source node 208 and collect information from an individual Pauli observable at a given time. Upon collecting a minimum number of Pauli observables needed, buffer 202 can perform a computation and release an output of the computation to receiver node 214.

More specifically, buffer 202 can accept individual Pauli operators as inputs in memory, and the release criterion for buffer 202 can be defined as N number of Pauli operators (e.g., “Collect N Pauli operators”), wherein N represents a positive integer representing the minimum number of Pauli operators needed for a task. Upon receiving each Pauli operator, buffer 202 can perform a computation (e.g., using computation component 110) to count a M number of Pauli operators received as input, wherein M represents a positive integer representing the number of Pauli operators counted by buffer 202. Further, buffer 202 can update (e.g., using update component 112) the value of M upon receiving additional Pauli operators as inputs, and buffer 202 can check (e.g., using update component 112) whether the updated M number of Pauli operators exceeds the threshold N number of Pauli operators defined by the release criterion (i.e., if M>N).

If the value of M does not exceed the value of N, buffer 202 can continue to accept individual Pauli operators, count the number M of Pauli operators, and check whether the value of M exceeds the value of N. Upon the value of M number of Pauli operators exceeding the N number of Pauli operators, buffer 202 can perform an additional computation (e.g., using computation component 110) to determine a minimum number (e.g., O) of measurement rotation circuits for measuring the M number of Pauli operators as efficiently as possible, and buffer 202 can release the O number of the measurement rotation circuits to receiver node 214, wherein O represents a positive integer. Ideally, the O number of the measurement rotation circuits can be less than the M number of Pauli operators.

In this application, source node 208 can be a classical computer, and receiver node 214 can be a quantum computer. Receiver node 214 can execute the O number of the measurement rotation circuits and return results of the execution to a quantum hardware. With reference to FIG. 1, the M number of Pauli operators for M>N can represent result 120, and the O number of the measurement rotation circuits can represent the output generated by buffer 202 based on result 120. A connectivity graph can be used to show that the M number of Pauli observables can be measured with the O number (O<M) of measurement rotation circuits computer by buffer 202 (e.g., using computation component 110). The connectivity graph can demonstrate that different Pauli observables such as, XI, IX, XX, etc. can be measured with the same quantum circuit.

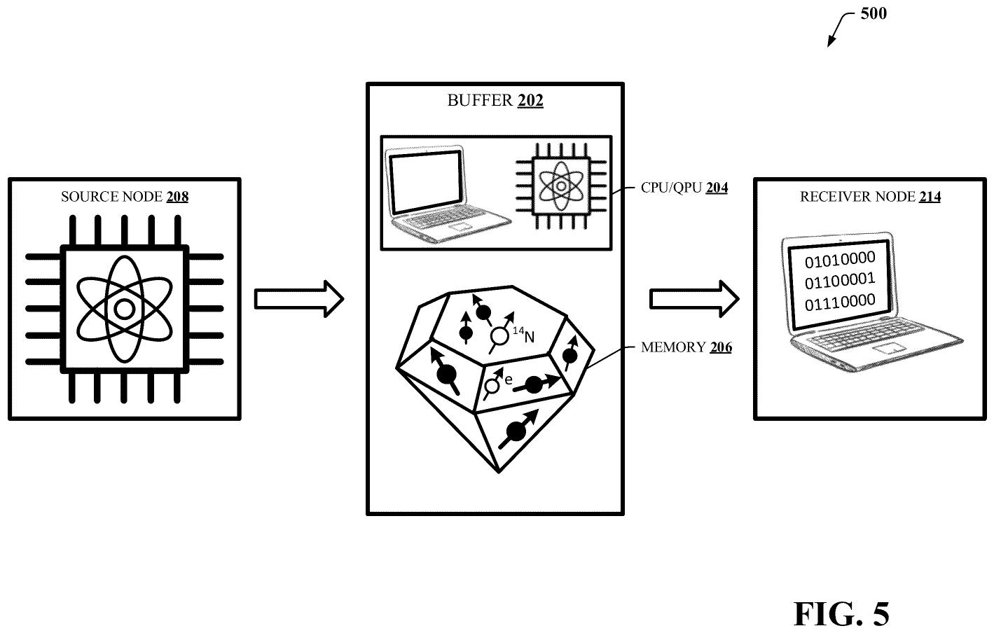

FIG. 5 illustrates yet another flow diagram of an example, non-limiting process 500 of using a buffer for streaming payloads in accordance with one or more embodiments described herein. One or more embodiments described with reference to FIG. 5 can be performed by one or more components of FIG. 1. Repetitive description of like elements and/or processes employed in respective embodiments is omitted for sake of brevity.

As stated elsewhere herein, convergence can be a significant release criterion in quantum supercomputing because quantum computers are probabilistic machines that can collect data over several shots, and results of data collected can be averaged to generate a final answer. For example, a plot of expectation value (Y-axis) versus number of shots (X-axis) can show that values can be sampled over time or several times with a quantum computer, and a result of the sampling can be expected to converge to some value with some fluctuations on the value. With continued reference to FIG. 2, buffer 202 (e.g., system 100) can be used for dynamic termination of expectation value estimation. For example, buffer 202 can accept (e.g., via receiver component 108) bitstrings from shots as inputs from source node 208, and a release criterion for buffer 202 can be defined based on an expectation value that should converge under 0.01 (e.g., “Expectation value should converge under 0.01”). Upon receiving bitstrings as inputs, buffer 202 can store the bitstrings in memory, and buffer 202 can compute (e.g., using computation component 110) an expectation value from all bitstrings in memory. For example, for each new bitstring received as input, buffer 202 can compute an expectation value for all bitstrings in memory, and buffer 202 can update an expectation value generated during a previous iteration. Further, buffer 202 can check (e.g., using update component 112), whether the bitstring value converges under 0.01 compared to the previous iteration. Algorithm 2 can be an example implementation of dynamic termination of the expectation value calculation.

Algorithm 2:

```
pub struct ExpValDynamicTerminationType {
  lastIteration: Float,
  threshold: Float = 0.01,
  converged: Boolean = false
}
impl Type for ExpValDynamicTerminationType {
  pub fn process(inputs: HashMap) {
    expectationValue = inputs[“expectationValue”];
    if (lastIteration − expectationValue).abs( ) < self.threshold {
      self.converged = true
    }
    self.lastIteration = expectationValue
  }
  pub fn checkCriteria( ) { self.converged }
  pub fn release(sink: Channel) { self.sink.publish(self.lastIteration) }
}
```

pub type ExpValDynamicTerminationBuffer=
Buffer<ExpValDynamicTerminationType>;
buffer=ExpValDynamicTerminationBuffer(source, sink)

If the expectation value does not converge according to the release criterion, buffer 202 can continue to accept bitstrings as inputs, compute expectation values from all bitstrings in memory and checking if a latest expectation value is within the predefined tolerance for the release criteria/convergence criteria defined beforehand. If the expectation value converges, buffer 202 can submit new noise factors to a quantum backend, and buffer 202 can compute (e.g., using computation component 110) the converged expectation value. That is, buffer 202 can adaptively determine the noise factors at which the expectation values should be measured, for a goal of computing the zero-noise expectation value using the results of expectation values at different noise factors. Thereafter, buffer 202 can output (e.g., using output component 114) the converged expectation value to receiver node 214, wherein the output can be received by a user.

In this application, source node 208 can be a quantum computer, and receiver node can be a classical computer. With reference to FIG. 1, the expectation value computed by buffer 202 can represent result 120, and the converged expectation value computed by buffer 202 can represent the output generated by buffer 202 based on result 120.

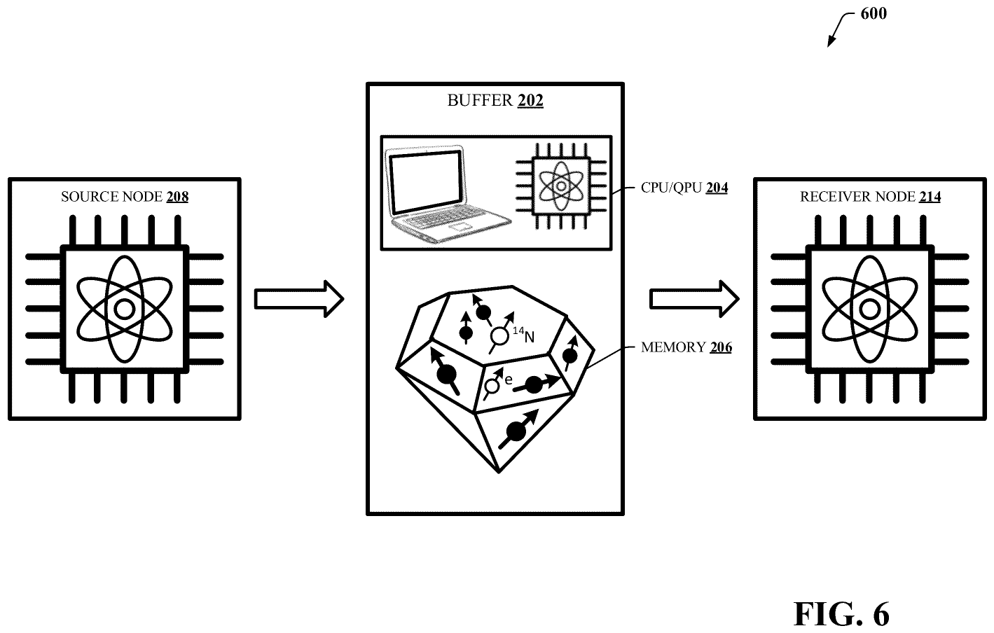

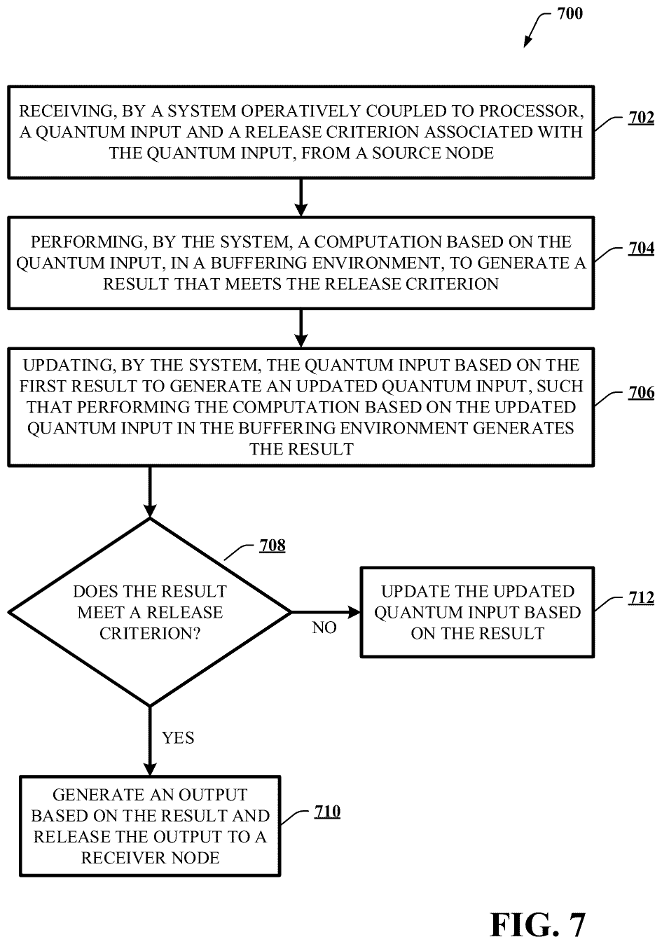

FIG. 6 illustrates yet another flow diagram of an example, non-limiting process 600 of using a buffer for streaming payloads in accordance with one or more embodiments described herein. One or more embodiments described with reference to FIG. 7 can be performed by one or more components of FIG. 1. Repetitive description of like elements and/or processes employed in respective embodiments is omitted for sake of brevity.

With continued reference to FIG. 2, buffer 202 (e.g., system 100) can be used for state verification or verification of a quantum state. For example, buffer 202 can accept (e.g., via receiver component 108) a quantum state as input and store the quantum state in a quantum memory slot. In this application, a release criterion for buffer 202 can be defined in terms of occupancy of the memory (e.g., “a state A and a state B should be received in memory slots C and D”). Buffer 202 can receive the quantum state as input, and buffer 202 can probe (e.g., using computation component 110) quantum memory slots of memory 206 to determine the number of slots occupied by quantum states. Further, buffer 202 can check (e.g., using update component 112) whether both memory slots are occupied.

If both memory slots are not occupied, buffer 202 can continue to accept quantum states, probe the quantum memory slots upon receiving each new quantum state, and check whether the release criterion is satisfied. Upon both memory slots being occupied according to the release criterion, buffer 202 can compute (e.g., using computation component 110) a fidelity of state A and state B with a SWAP test. After computing the fidelity, buffer 202 can release the fidelity to receiver node 214 as needed by receiver node 214. In this application, source node 208 and receiver node 214 can both be quantum computers. The SWAP test can be one method of computing fidelity between states A and B, and ‘SWAP’ can refer to a literal swapping of quantum states. When a controlled swap is performed, information that can get projected to a qubit in a zero state can be the fidelity. For example, in various embodiments, buffer 202 can compute fidelity between a first quantum state (e.g., Ø) and a second quantum state (e.g., y) by running a quantum circuit, and information can become projected onto a qubit in the zero state, wherein the information can represent the fidelity.

FIG. 7 illustrates a flow diagram of an example, non-limiting method 700 that can provide a buffering environment for streaming payloads in accordance with one or more embodiments described herein. One or more embodiments described with reference to FIG. 7 can be performed by one or more components of FIG. 1. Repetitive description of like elements and/or processes employed in respective embodiments is omitted for sake of brevity.

At 702, the non-limiting method 700 can comprise receiving (e.g., by receiver component 108), by a system operatively coupled to processor, a quantum input and a release criterion associated with the quantum input, from a source node.

At 704, the non-limiting method 700 can comprise performing (e.g., by computation component 110), by the system, a computation based on the quantum input, in a buffering environment, to generate a result that meets the release criterion.

At 706, the non-limiting method 700 can comprise updating (e.g., by update component 112), by the system, the quantum input based on the first result to generate an updated quantum input, such that performing the computation based on the updated quantum input, in the buffering environment, can generate the result.

At 708, the non-limiting method 700 can comprise determining (e.g., by update component 112), by the system, whether the result meets the release criterion.

If yes, at 710, the non-limiting method 700 can comprise generating (e.g., by computation component 110), by the system, an output based on the result, and releasing (e.g., by output component 114), by the system, the output to a receiver node.

If no, at 712, the non-limiting method 700 can comprise updating (e.g., by update component 112), by the system, the update component based on the result.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively stream quantum information for real-time decision making in quantum-centric supercomputing as the one or more embodiments described herein can enable this process. And, neither can the human mind nor a human with pen and paper monitor results generated in a buffering environment based on a release criterion, as conducted by one or more embodiments described herein.

In summary, various embodiments herein can provide a framework and protocol for transmitting calculations between quantum computers and classical computers. In some embodiments, approaches described herein can converge to a particular precision by increasing the number of shots, executions or operator measurements of a quantum circuit. This can allow noise due to an inherent probabilistic nature of quantum computing to be automatically managed without input from the user. As such, various embodiments herein can allow controlling statistical noise through a release criterion of a convergence level. In other embodiments, the approaches described herein can use efficient measurement bases to more efficiently measure each of the measurement bases to estimate an expectation value within a particular precision. In general, various embodiments herein can release a quantum computation upon fulfilling a release criterion. Depending on the application, the release criterion can be a particular precision, a time window, convergence, the size of the memory or dataset, whether enough gates have been received to form a dense circuit layer, whether all expectation values of interest have been received, or whether certain quantum states have been stored, etc.

Embodiments discussed herein can provide a number of advantages to quantum computing systems, including efficient and speedy transmission of payloads between modules to allow for streaming data for real-time decision making in quantum-centric supercomputing, improved QPU utilization by minimizing compilation at an end point to a quantum hardware, and faster development of quantum computing products with a flexible and powerful quantum-centric software framework. In the future, embodiments of the present disclosure can be extended to multiplexed inputs and/or outputs, and quantum memory and processing for quantum-to-quantum buffering. Streaming of data provided by embodiments of the present disclosure can also be explored in the future for protocols for maintaining security when communicating with external nodes, adapting existing classical protocols for quantum data, and communicating with layers of stack at higher levels of abstraction.

FIG. 8 illustrates a block diagram of an example, non-limiting operating environment 800 in which one or more embodiments described herein can be facilitated. FIG. 8 and the following discussion are intended to provide a general description of a suitable operating environment 800 in which one or more embodiments described herein at FIGS. 1-7 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as quantum input buffering code 845. In addition to block 845, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 845 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a receiver component that receives, from a source node, a quantum input and a release criterion associated with the quantum input; and
a computation component that performs a computation based on the quantum input, in a buffering environment, to generate a result that meets the release criterion.

2. The system of claim 1, wherein generating the result comprises performing the computation in the buffering environment for at least a first iteration to generate a first result.

3. The system of claim 2, further comprising:
an update component that updates the quantum input based on the first result to generate an updated quantum input, such that performing the computation based on the updated quantum input in the buffering environment generates the result.

4. The system of claim 3, wherein the update component further updates the updated quantum input based on the result if the result does not meet a release criterion.

5. The system of claim 1, further comprising:
an output component that outputs the result to a receiver node, wherein the receiver node is a quantum device or a classical device.

6. The system of claim 1, wherein the source node is a quantum device or a classical device.

7. The system of claim 1, wherein generating the result based on the release criterion increases efficiency of performing computations for a receiver node.

8. A computer-implemented method, comprising:
receiving, by a system operatively coupled to processor, a quantum input and a release criterion associated with the quantum input, from a source node; and
performing, by the system, a computation based on the quantum input, in a buffering environment, to generate a result that meets the release criterion.

9. The computer-implemented method of claim 8, wherein generating the result comprises performing the computation in the buffering environment for at least a first iteration to generate a first result.

10. The computer-implemented method of claim 9, further comprising:
updating, by the system, the quantum input based on the first result to generate an updated quantum input, such that performing the computation based on the updated quantum input in the buffering environment generates the result.

11. The computer-implemented method of claim 10, further comprising:
updating, by the system, the updated quantum input based on the result if the result does not meet a release criterion.

12. The computer-implemented method of claim 8, further comprising:
outputting, by the system, the result to a receiver node, wherein the receiver node is a quantum device or a classical device.

13. The computer-implemented method of claim 8, wherein the source node is a quantum device or a classical device.

14. The computer-implemented method of claim 8, wherein generating the result based on the release criterion increases efficiency of performing computations for a receiver node.

15. A computer program product for enabling buffers for streaming in quantum-centric supercomputing, the computer program product comprising a computer readable storage medium having program instructions embodied therewith, the program instructions executable by a processor to cause the processor to:
receive, by the processor, a quantum input and a release criterion associated with the quantum input, from a source node; and
perform, by the processor, a computation based on the quantum input, in a buffering environment, to generate a result that meets the release criterion.

16. The computer program product of claim 15, wherein generating the result comprises performing the computation in the buffering environment for at least a first iteration to generate a first result.

17. The computer program product of claim 16, wherein the program instructions are further executable by the processor to cause the processor to:
update, by the processor, the quantum input based on the first result to generate an updated quantum input, such that performing the computation based on the updated quantum input in the buffering environment generates the result.

18. The computer program product of claim 17, wherein the program instructions are further executable by the processor to cause the processor to:
update, by the processor, the updated quantum input based on the result if the result does not meet a release criterion.

19. The computer program product of claim 15, wherein the program instructions are further executable by the processor to cause the processor to:
output, by the processor, the result to a receiver node, wherein the receiver node is a quantum device or a classical device.

20. The computer program product of claim 15, wherein the source node is a quantum device or a classical device.
